(19) United States
(12) Patent Application Publication
(10) Pub. No.: US 2005/0000159 A1
(43) Pub. Date: Jan. 6, 2005

(54) Hydroponic pot with a root prune window

(76) Inventor: Richard Joseph Billette, San Rafael Marin County, CA (US)

Correspondence Address: Leon E Jew;The Schinner Group, 96 Jessie Street, San Francisco, CA, 94105, US

(21) Appl. No.: 10/485,130

(22) PCT Filed: Jul. 26, 2002
(86) PCT No.: PCT/US02/23945

Related U.S. Application Data
(60) Provisional application No. 60/308,754, filed on Jul. 30, 2001.

(51) Int. Cl. A01G 25/00

(52) U.S. Cl. 47/79

(57) ABSTRACT

The present invention provides an apparatus (100) for hydroponic cultivation of plants with a root retaining mechanism for preventing primary roots from traveling from a growing chamber (101) into a nutrient solution reservoir (102). The combined features of the root retaining mechanism and a root prune window (108) provide a high capacity for the plant to reach its maximum potentials.

### TECHNICAL FIELD

This invention relates to hydroponic cultivation of plants using an irrigation system. More particularly, the invention relates to an improved hydroponic apparatus providing an aerated solution to the roots of plants grown hydroponically therein.

### BACKGROUND ART

Hydroponics, simply stated, is the growing of plants without soil. Hydroponic cultivation of plants involves inert root growth mediums without microbial activity. The solution is principally water with fertilizers and other nutrients added. Scientists have discovered that ten elements are generally required for plant growth. Three of these ten are provided by air and water: carbon (C), hydrogen (H) and oxygen (O). The others, nitrogen (N), phosphorus (P), potassium (K), calcium (Ca), magnesium (Mg), sulfur (S) and iron (Fe) were obtained by plants from the soil or other growing medium. Six additional elements have been determined essential for plant growth: manganese (Mn), zinc (Zn), copper (Cu), boron (B), molybdenum (Mb) and chlorine (Cl). Currently accepted organic fertilizer components are dependent upon organisms in the soil to convert the “organic” materials into a useable form for plants. In hydroponics, because the minerals required for plant growth are provided, the need for soil and soil organisms are completely eliminated. The result is much higher growth rates and yields, and better crop quality than organic methods can achieve.

FIG. 1 is a schematic diagram illustrating a hydroponic pot representing the current state of art. A growing chamber 10 filled with growing medium 11 sits in a nutrient reservoir 12. A pumping column 13 fits into a pumping pipe 14, reaching into the nutrient solution contained in the reservoir 12. Air pressure from the air pump 15 pushes the solution up through the pumping column 13 to the drip ring 16 with a number of drip holes. The drip ring 16 is connected to the column with a tee connector. Solution drains to a drain/level tube 17, which is inserted through a rubber grommet at the bottom of the reservoir 12.

The growing chamber 10 is a shallow pot with perforated bottom. The holes in the bottom of the growing chamber 10 are in three sizes—large, medium and small ones, all evenly spread. The small holes are for draining the solution oozed through the growing medium 11. The medium and large holes are primarily for the roots to grow through into the reservoir 12.

This apparatus has many problems in use. First, the premise of this methodology is a failed premise because the roots submerged in an oxygen deprived nutrient solution reservoir soon drown.

Second, because the drain holes are spread all over the growing chambers bottom the primary roots are evacuated into the reservoir. Saturation of unpruned roots in the reservoir clogs the pumping column 13. A biweekly disassembly is required to remedy this design flaw.

Third, to prevent the roots from entering the reservoir they must be pruned. This involves the cumbersome task of removing the whole growing chamber 10 off the reservoir 12. In addition, upon pruning of the primary roots the plant is left dependent upon secondary roots only. This further limits the plant's growth capacity.

Fourth, the nutrient solution is not oxygen enriched. This results in a slower rate of metabolism. It is established that at 72° F., O₂ and H₂O become H₂O₂. The metabolic rate increases when a plant uptakes the water with a molecule of oxygen.

Fifth, the nutrient solution temperature is not stable and is affected by environmental influences such as outside at night, as the solution temperature fluctuates so does the metabolic rate. This single instability can shock a sensitive plant and stunt its growth.

Sixth, due to the design of the drain level tube 17, weekly solution drain and rinse is inconvenient, the entire device must be lifted in the air as the drain tube is at the bottom of the reservoir.

Seven, the nutrient drip ring 16, is a single ring with minimal drip holes exposing perhaps 10% of the root mass to nutrient. The design depends primarily upon roots entering the reservoir for nutrients.

Taken altogether, the above described is at best a nominally successful methodology. The device works fine until the roots enter the reservoir. The plant is then forced into premature catabolic activity.

It is therefore an object of the present invention to solve these problems by providing an apparatus for hydroponic cultivation of plants that provides a high capacity for the plant to reach its maximum potentials.

### SUMMARY OF THE INVENTION

The present invention provides an apparatus for hydroponic cultivation of plants with a root retaining mechanism for preventing primary roots from traveling from a growing chamber into a pot reservoir. The combined features of the root retaining mechanism and a root prune window provide a high capacity for the plant to reach its maximum potentials.

In one preferred embodiment of the invention, the hydroponic pot comprises:
a first cylindrical container for keeping a growing medium, the first cylindrical container having a surrounding wall and a bottom with a number of holes which evenly spread in a central area of the bottom;
a second cylindrical container as a reservoir of nutrient solution, the second cylindrical container being coupled to, and positioned under, the first cylindrical container, and the second cylindrical container having a window from which a user observes and prunes a plant's roots extending downward into said reservoir through the small round holes, the window's upper edge being as close as possible to the bottom's lower surface; and
an irrigation system to pump nutrient solution from the reservoir upward into the growing medium.

In another preferred embodiment, the hydroponic pot comprises:
a cylindrical tank which is divided by a divider into an upper portion as a growing chamber which is filled with a growing medium, and a lower portion as a reservoir of nutrient solution; and
a pump which pumps nutrient solution from the reservoir upward into the growing medium through a drip irrigation base;
wherein the divider is a round member that fits into the tank, acting as the growing chamber's bottom to support the growing medium, the round member having a smooth upper surface and a number of holes which evenly spread in a central area of the round member; and
wherein the reservoir has a window from which a user observes and prunes a plant's roots extending downward into the reservoir through the holes of the divider, the window's upper edge being as close as possible to the divider's lower surface.

In both of the embodiments, the hydroponic pot may further comprises the following components:
a submersible heater which is used to adjust the temperature of nutrient solution in the nutrient reservoir;
an aeration device, such as an aeration stone coupled to an air pump, to aerate the nutrient solution in the nutrient reservoir;
a programmable controller to control aeration and temperature of the nutrient solution as well as the humidity of the growing medium;
a drainage which is used to empty the reservoir;
a trestle coupled to the pot's upper edge;
a lighting device coupled to the trestle to promote photosynthesis; and/or
a power interruption device to ensure that the power is automatically shut off when a short circuit occurs.

### BRIEF DESCRIPTION OF DRAWINGS

FIG. 1 is a schematic diagram illustrating a hydroponic pot according to the prior art;

FIG. 2 is a schematic, sectional view diagram of an improved hydroponic pot with a root prune window according to one preferred embodiment of the invention;

FIG. 3 is a schematic, top view diagram of an exemplary drip irrigation base with a grid of drip holes, which is placed at the top of the growing medium;

FIG. 4 is a schematic, partially sectional view diagram of the hydroponic pot illustrating an exemplary framework of the nutrient pumping conduits;

FIG. 5 is a schematic diagram of an exemplary design of the primary pot's bottom having a number of drain holes, locating in the central area of the bottom;

FIG. 6 is a front view diagram of the tank of an improved hydroponic pot with a root prune window according to another preferred embodiment representing the best mode for carrying out the invention;

FIG. 6A is a sectional view diagram illustrating the upper edge of the window and a notch used to hold the sliding door from falling;

FIG. 6B is a sectional view illustrating the lower edge of the window and a notch used to hold the sliding door from falling;

FIG. 6C is a bottom view diagram further illustrating the window edges;

FIG. 6D is a sectional view diagram illustrating a track which enables the sliding door slide from right to left or from left to right;

FIGS. 7A-C illustrate the front view, side view, and top view of the sliding door respectively;

FIG. 8A is a top view diagram of a divider which is used to divide the tank into an upper portion as a growing chamber and a lower portion as a reservoir;

FIG. 8B is a side view of a divider which has a flat top surface;

FIG. 9A and FIG. 9B are top view and side view diagrams respectively, illustrating a divider, whose central area is slightly higher than its surrounding area so that the primary roots are encouraged to grow toward the surrounding wall of the tank;

FIG. 10 is a sectional view diagram of an irrigation base with one input conduit connected to a number of circular conduits with a number of drip holes; and

FIGS. 11A-B illustrate a trestle which includes a ring-shape base and seven rods coupled to the ring-shape base.

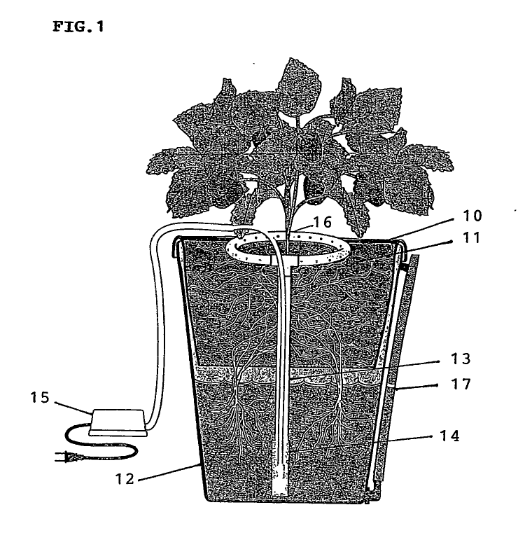

### DISCLOSURE OF THE INVENTION

The present invention provides an apparatus for hydroponic cultivation of plants. The approaches according to this invention have solved the problems of root saturation in a reservoir by a unique control mechanism for preventing primary roots from traveling from a growing chamber into a nutrient reservoir. The combined feature of a root retaining system and a root prune window provides a high capacity for the plant to reach its maximum potentials.

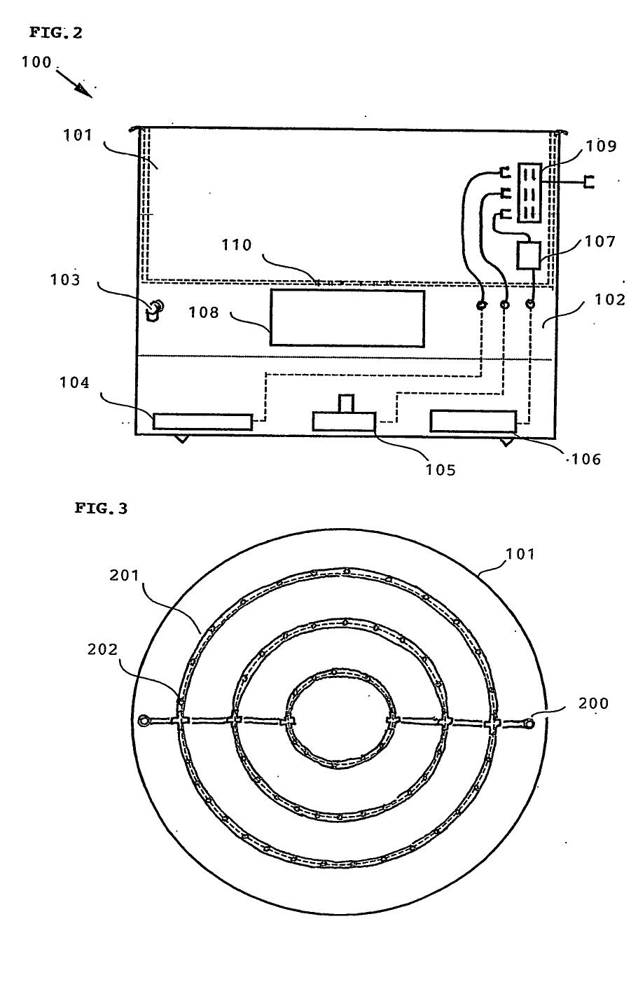

FIG. 2 is a schematic, sectional view diagram of an improved hydroponic pot 100 according to one preferred embodiment of the invention. The hydroponic pot includes a primary pot 101 as a growing chamber where a growing medium is kept and a plant is cultivated, a pot reservoir 102 of nutrient solution with a root prune window 108, a drainage 103 which is used to empty the reservoir 102, an electrical submersible pump 105 which is used to pump the nutrient solution to an irrigation base, and a parts kit 109. The submersible pump 105 is oil-less to prevent any possibility of contamination.

The primary pot 101 is filled with a non-soil growing medium which can be peat moss, coco fiber, little round lava rocks, baked clay pebbles or rockwool. The coating on the growing medium holds moisture and air that are useful in promotion of the plant's metabolism. To keep the humidity in the growing chamber, the top of the primary pot may be wrapped with saran or other material.

Plants have two types of roots, water roots and air roots. Roots growing mediums are designed for one or the other, not for the both. Therefore, a combination of mediums is required. Water roots that prefer the lower region of the pot are given a rockwool mat while the air roots which prefer the upper region of the pot are given clay pebbles or lava rocks. The success of this strategy is physically evident upon removal of the plant at the end of its lifecycle.

The primary pot 101 is a standard five-gallon round pot that sits above a five-gallon reservoir 102. The primary pot 101 can be conveniently removed from the reservoir 102. The primary pot and the reservoir in pair can be in any shape such as square or oval, and any size acceptable in the industry, such as one-one gallon pots, three-three gallon pots, or ten-ten gallon pots.

The root prune window 108 on the pot reservoir 102 is for the convenience of observing and pruning the secondary roots without a need to move the primary pot 101 from the reservoir 102. The window 108 is as close as possible to the primary pot's bottom. It can be opened and closed using a door such as a sliding door. It is opened when a user need to observe and prune the plant's roots. It is usually closed for keeping the inside humidity and temperature best for the plant's metabolism. It may be in any shape, such as oval or square. In addition, it is preferably non-transparent for preventing the roots from light. After the roots have saturated the pot, they make their way toward and out the nutrient drain holes where they are easily pruned via the window. The result is that the life expectancy of the plant is now made indefinite. This is important for outdoor applications where the growing season is six months or longer.

The hydroponic pot 100 further comprises a submersible heater 104, which is used to adjust the temperature of the solution in the reservoir 102. The heater 104 may be a 50-watt aquarium heater. It is electrically connected to the power by plugging in the plug to the plug strip 109. The heater 104 may be controlled by an on-or-off switch or by a programmable controller. Experiments indicate that the metabolic rate is governed primarily by temperature. Maintaining a nutrient solution temperature of 72° F. contributes significantly to increases in metabolic rate. 72° F. is also the optimum temperature for the mechanical bonding of H₂O and O₂ molecules. This process of H₂O₂ acts as a compounding factor to further effect increases in metabolic rate; a nutrient solution heater and air pump provide optimum support for this process. Enhanced metabolism allows the plant to perform to its fullest. Stabilization of root zone temperature, via maintenance of nutrient solution temperature, insulates the plant against environmental stresses such as outdoors at night. Tests conducted on outdoor tomato plants have demonstrated that this stabilization contributes to longer daily cycles of plant respiration, i.e. the processing of CO₂.

The hydroponic pot 100 further comprises an aeration stone 106, which is placed in the nutrient solution and is operatively coupled to an air pump 107 which is used to aerate the water to maximize the H₂O₂ process described above. For the connection between the stone 106 and the air pump 107, a simple plug or an on-or-off switch may be used. Alternatively, a programmable control may be used to control the air pump.

Experiments indicate that vigorous growth, or even survival of the plants requires that the roots be provided with an oxygen-enriched solution and kept within a proper environment. By infusing air into the nutrient solution, the solution is oxygen-enriched, and thus the roots absorb optimal levels of both oxygen and nutrients. This facilitates rapid growth resulting in optimum yields.

The parts kit 109 may be a plug strip, or a combination of switches or a programmable controller. It may include a breaker that pops and shuts off the power when any of the electrical items is short-circuited for any reason. It may also include a reset button used to return the power when the short-circuit problem is solved. It may further include other auxiliary items such as signal lights, or temperature, pH level and nutrient concentration indicators.

FIG. 3 is a schematic, top view diagram of an exemplary drip irrigation base 200, which is placed at the top of the growing medium. The irrigation base 200 includes a number of circular pipes 201 connected to the pump conduits, each pipe having a number of small drip holes 202 facing upward, constituting a full coverage drip irrigation grid which provides constant nutrient to the plant.

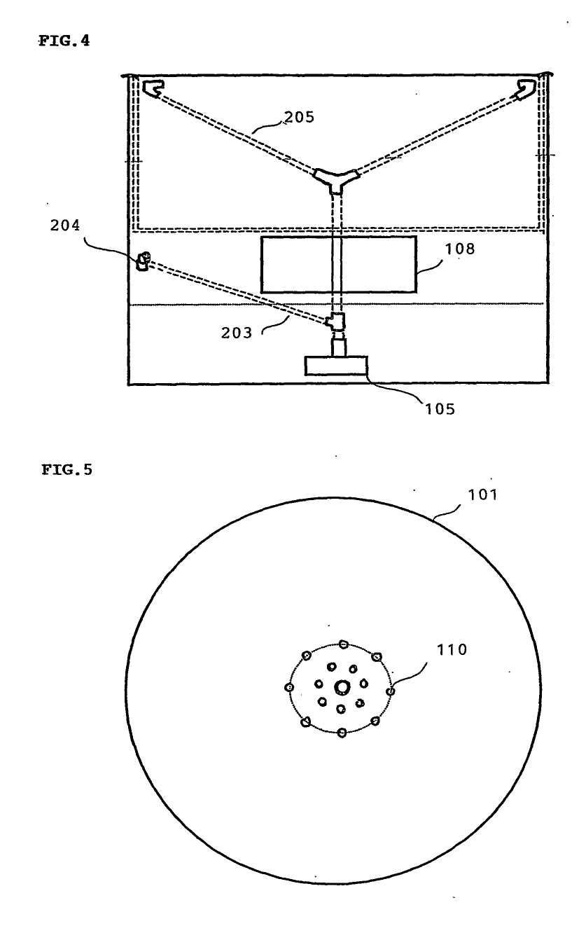

FIG. 4 is a schematic, partially sectional view diagram of the hydroponic pot 100 illustrating an exemplary framework of nutrient pumping conduit 205. Also referring to FIG. 2 and FIG. 3, the pump 105 is used to pump the nutrients from the reservoir 102 to the irrigation base 200. The nutrients drip from the drip holes 202, go through the growing medium, and then descend through the drain holes 110, into the reservoir 102. The drainage 103 includes a pipe 203 coupled to the pump 105 and a little cap 204. When the little cap 204 is taken off, the pressure of the upper portion of the irrigation system decreases and thus the pump 105 may have the reservoir drained so that new nutrients may be added.

FIG. 5 is a simplified bottom view diagram of the primary pot 101 illustrating the nutrient drain holes 110 which represent a root-retaining system. Nutrient drain holes 110 evenly spread in the central area of the primary pot's bottom, thereby, encouraging the primary roots to elongate along the primary pot's surrounding wall. Preferably, the central area of the bottom is slightly higher, with a smooth slope, than the surrounding area. The slight upgrade for the drain holes is also a slight downgrade for the roots, which leads the roots away from the center of the primary pot's bottom. This root-retaining system ensures large root mass that translates into large plants. Furthermore, the plant reads the lengthy forty-eight inches inside circumstance of the pot as a less limiting environment, which further contributes to the potential of plant growth. In a typical embodiment, the central area's diameter is approximately 1/3 of the diameter of the primary pot's bottom. Alternatively, the drain holes can be unevenly spread. For a 5-5 gallon pot, the root-retaining system may have twelve to twenty-four evenly spread drain holes. Each of such drain holes may be approximately 5/16 to ⅜ inch big in diameter. The drain holes may be in any shape, such as triangular or square, although they are not as practical as the round holes.

With the growing of the plant cultivated in the hydroponic pot, its primary roots come out and grow toward the surrounding wall of the growing chamber, i.e., the primary pot 101. When the primary roots hit the wall, they go around the pot to grow further. Because the drain holes are limited in the central area of the pot's bottom, the primary roots grow around the pot. In other words, they do not go straight through the drain holes into the reservoir 102. It takes a relatively long time for the primary roots to reach the central area where the nutrient drain holes 110 are located. At this time the roots begin to extrude through the drain holes 110 and are then pruned via the root prune window 108. The plant roots quickly understand that they must seek an alternative route and extrusions diminish. In this system, the plant has sufficient time and space to grow its primary roots and therefore can reach its maximum potentials.

The hydroponic pot may further include a trestle to support several plants. The trestle includes a number of straight rods coupled to a ring-shape base that is mechanically connected to the upper portion of the pot. The ring-shape base also functions as a cover of the growing medium to maintain the humidity inside the growing chamber. Preferably, the ring-shape base covers approximately one-third to one-half of the upper surface of the growing chamber.

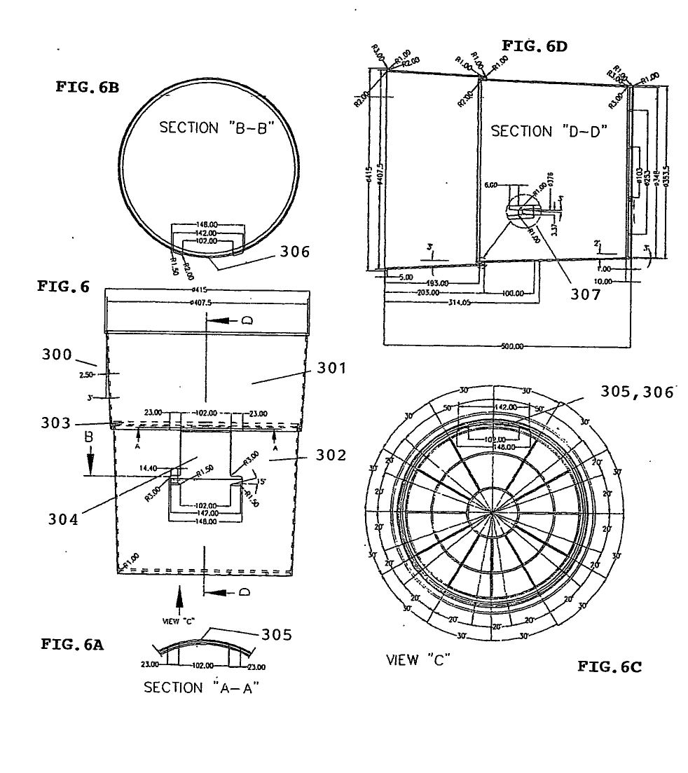

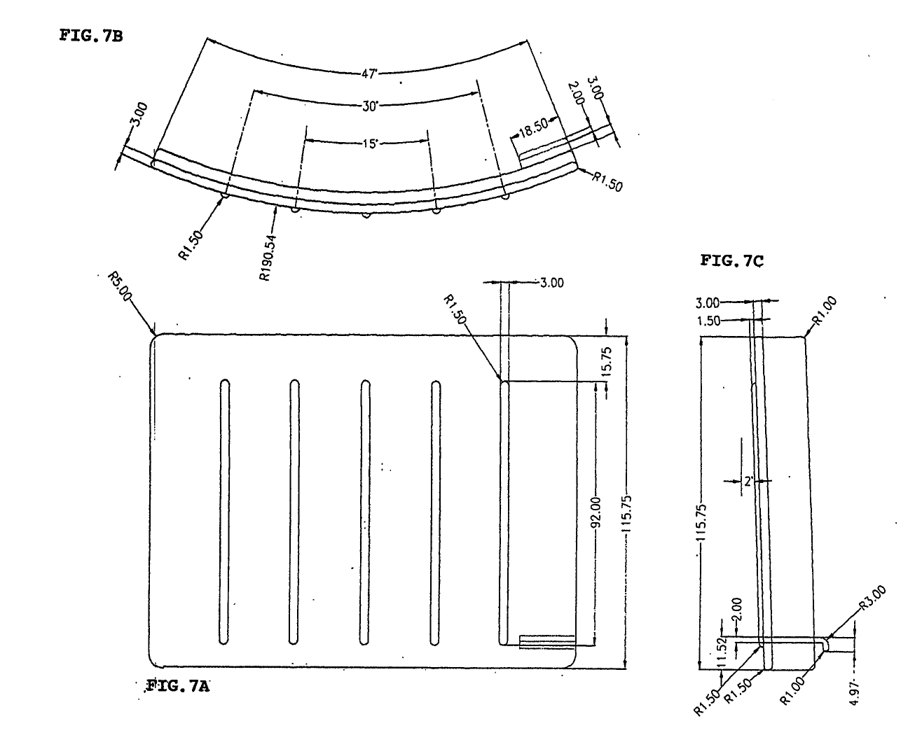

FIG. 6 is a front view diagram of the tank 300 of an improved hydroponic pot according to another preferred embodiment representing the best mode for carrying out the invention. In this embodiment, hydroponic pot has only one container, i.e., the tank 300, which is divided into two portions by a divider 303. The upper portion 301 is used as a growing chamber, and the lower portion 302 as a nutrient reservoir. The lower portion has a root prune window 304, which is open and closed by a sliding door operatively coupled to the tank 300. FIG. 6A is a sectional view diagram illustrating the upper edge 305 of the window 304 and a notch used to hold the sliding door from falling. FIG. 6B is a sectional view illustrating the lower edge 306 of the window 304 and a notch used to hold the sliding door from falling. FIG. 6C is a bottom view diagram further illustrating the window edges 305, 306. FIG. 6D is a sectional view diagram illustrating a track 307 which enables the sliding door slide from right to left or from left to right. FIG. 7A, FIG. 7B, and FIG. 7C illustrate the front view, side view, and top view of a sliding door 308 respectively.

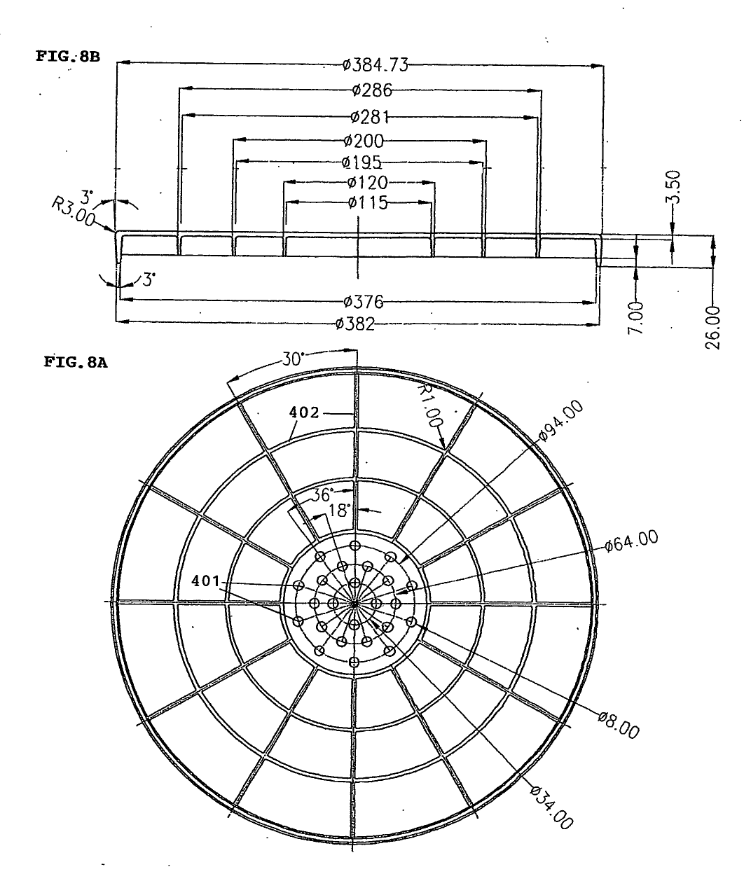

FIG. 8A is a top view diagram of a divider that is used to divide the tank 300 into the upper portion 301 as a growing chamber and the lower portion 302 as a reservoir. The divider has twenty-four drain holes 401 evenly spread in the central area. The top surface of the divider, i.e., the surface touching the growing medium is smooth. The bottom of the divider has a number of radial and circular ridges 402 to strengthen the divider. FIG. 8B is a side view of a divider that has flat top surface.

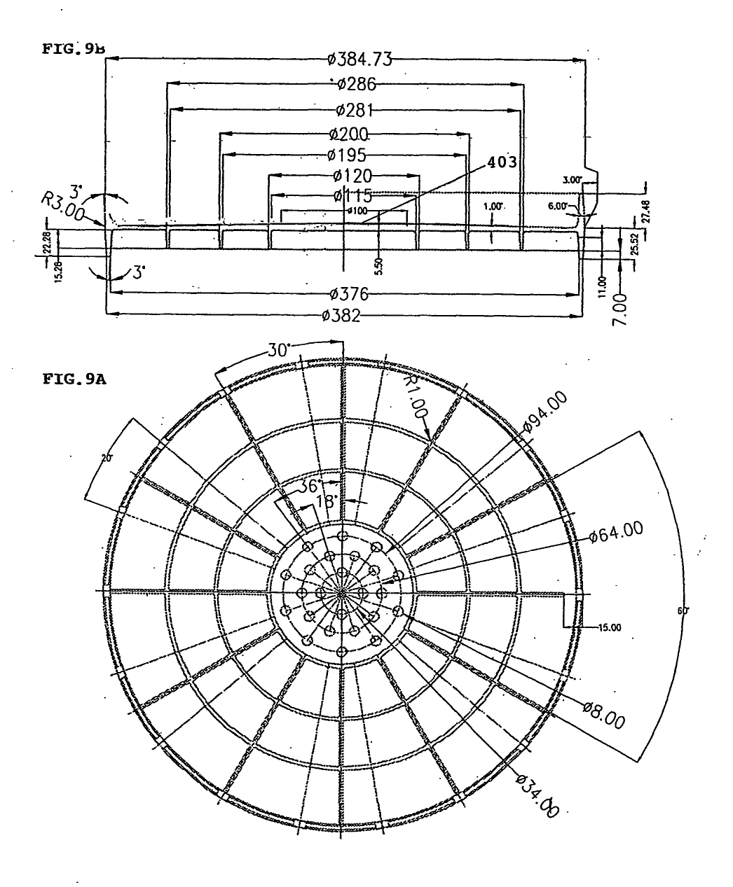

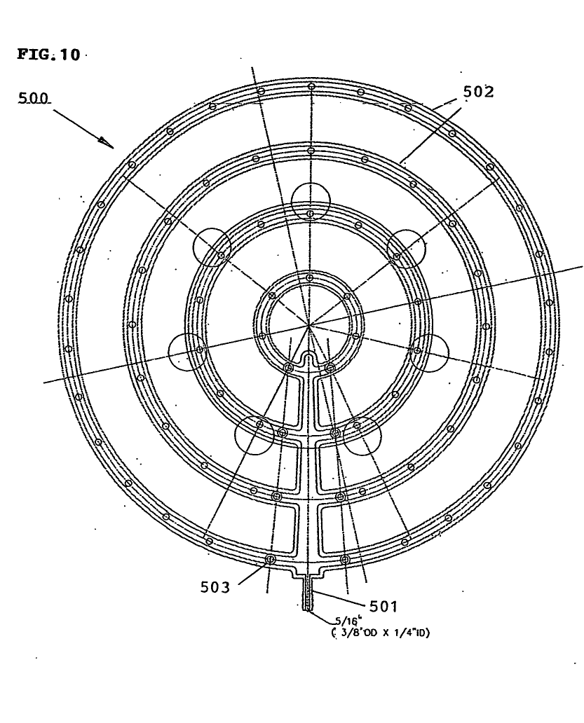

FIG. 9A and FIG. 9B illustrate a divider representing the most preferred mode. The central area 403 of the divider's top surface is slightly higher, with a smooth slope, than its surrounding area so that the primary roots are encouraged to grow toward the surrounding wall of the tank 300.

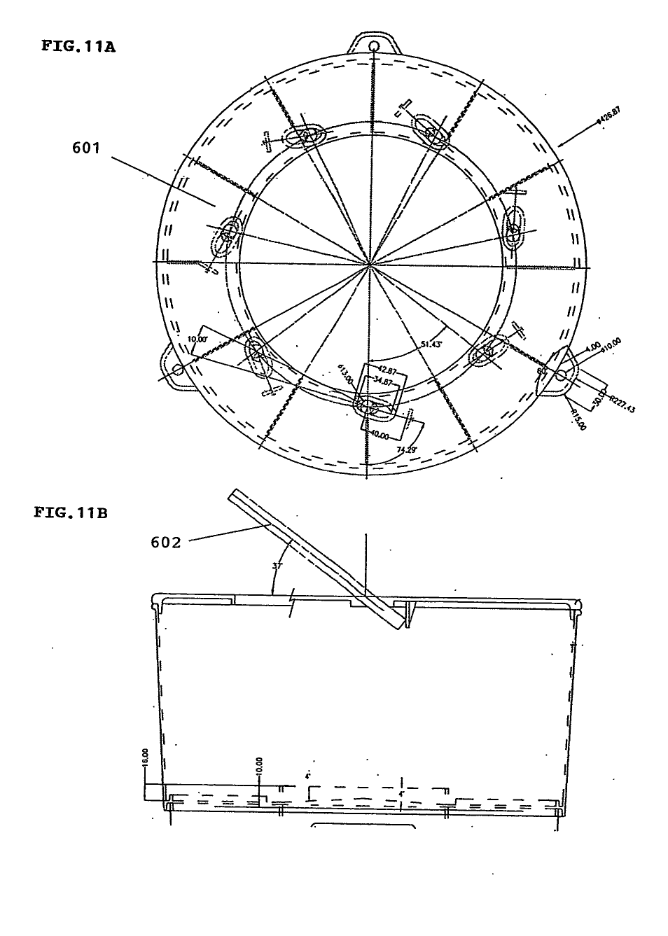

FIG. 10 is a sectional view diagram of an irrigation base 500 with one input conduit 501 connected to a number of circular conduits 502 with drip holes 503.

In a typical embodiment, the circular conduits can be removed and replaced. In another embodiment, the entire irrigation base 500 is molded.

FIG. 11A is a top view diagram of a trestle that includes a ring-shape base 601 and seven rods coupled to the ring-shape base. The rods are evenly spread, pointing at the tangent direction. As FIG. 11B shows, each rod 602 keeps a 370 angle with the base surface. The trestle may further include a web stretched by the top ends of the rods. The trestle is designed to (1) represent the several plants that the apparatus is capable of supporting, and (2) finish the plant out in the Maximum Lumen Zone on indoor applications.

The apparatus may further comprise a lighting device coupled to the trestle to promote photosynthesis. The lighting device may be a regular bulb, but preferably a 1000 waft vertical HPS with 4 feet parabolic hood.

The aeration device, the heating device, the nutrient pump device, the drainage, the drip irrigation base, the trestle, as well as the lighting device described above are equally applicable both to the first preferred embodiment illustrated by FIGS. 2-5 and to the second preferred embodiment illustrated by FIGS. 6-11.

Table 1 below illustrated the suggested values for the best performance of the hydroponic apparatus.

TABLE 1
Suggested Values

| | |
|---|---|
| Light | 1000 watt Vertical HPS with 4 ft Parabolic Hood |
| Nutrient | 1000 ppm, hydroponic nutrient only, pH 6.4 |
| CO₂ | 1000 ppm to start, progress incrementally to 2000 ppm |
| Temperature | Light Period, 80-85° F.; Dark period, 75-80° F. |
| Algae | 2-3 ml of 35% aqueous solution Hydrogen Peroxide (food |
| | grade) every 48 hrs |
| Rinse | Weekly, dark period only |

The apparatus described above can be used in a greenhouse, on a patio or deck and indoors under lights. It is energy efficient and low maintenance. It can work as a stand-alone unit or as an integrated chain of growers operatively connected to each other with a common reservoir.

Although the invention is described herein with reference to the preferred embodiments, one skilled in the art will readily appreciate that other applications may be substituted for those set forth herein without departing from the spirit and scope of the present invention.

Accordingly, the invention should only be limited by the claims included below.

1. A hydroponic apparatus comprising:
a first cylindrical container for keeping a growing medium, said first cylindrical container having a surrounding wall and a bottom with a number of vertical holes which evenly spread in a central area of said bottom;
a second cylindrical container as a reservoir of nutrient solution, said second cylindrical container being coupled to, and positioned under, said first cylindrical container, and said second cylindrical container having a window from which a user observes and prunes a plant's roots which grow downward into said reservoir through said vertical holes, said window's upper edge being as close as possible to said bottom's lower surface; and
an irrigation system to pump nutrient solution from said reservoir upward into said growing medium.

2. The hydroponic apparatus of claim 1, further comprising:
a submersible heater which is used to adjust the temperature of nutrient solution in said reservoir.

3. The hydroponic apparatus of claim 1, further comprising:
an aeration device to aerate nutrient solution in said reservoir.

4. The hydroponic apparatus of claim 3, wherein said aeration device comprises an aeration stone operatively coupled to an air pump.

5. The hydroponic apparatus of claim 1, further comprising a programmable controller to control any of:
aeration of nutrient solution in said reservoir;
temperature of nutrient solution in said reservoir; and
moisture of said growing medium.

6. The hydroponic apparatus of claim 1, wherein said irrigation system is coupled to an irrigation base which provides an array of drip holes facing upward from which nutrient solution evenly covers said growing medium.

7. The hydroponic apparatus of claim 6, wherein said irrigation base comprises one input conduit connected to at least two circular conduits on which various drip holes facing upward are evenly made.

8. The hydroponic apparatus of claim 1, wherein said growing medium can be any of:
peat moss;
coco fiber;
lava rocks;
clay pebbles; and
rockwool.

9. The hydroponic apparatus of claim 1, wherein each of said vertical holes is approximately 5/16-3/8 inch in diameter.

10. The hydroponic apparatus of claim 1, wherein said central area is an area whose diameter is approximately one-third of said bottom's diameter.

11. The hydroponic apparatus of claim 1, wherein said central area is slightly higher, with a smooth slope, than the surrounding area of said bottom to lead a plant's primary roots to grow toward the surrounding wall of said first cylindrical container.

12. The hydroponic apparatus of claim 1, wherein said window is opened and closed using a sliding door.

13. The hydroponic apparatus of claim 1, wherein said irrigation system comprises a drainage that is used to empty said reservoir.

14. The hydroponic apparatus of claim 1, further comprising a trestle coupled to said first cylindrical container's upper edge, said trestle comprising:
a connection agency for connection with said first cylindrical container; and
a number of rods with a same length, the lower ends of said rods being coupled to said connection agency.

15. The hydroponic apparatus of claim 14, wherein said trestle further comprises a web stretched by the upper ends of said rods.

16. The hydroponic apparatus of claim 14, wherein said connection agency covers, around said first cylindrical container's upper rim, approximately one-third to one-half of the top surface of said first cylindrical container to keep a particular humidity of said growing medium.

17. The hydroponic apparatus of claim 1, further comprising a lighting device coupled to said trestle to promote photosynthesis.

18. The hydroponic apparatus of claim 1, further comprising:
a power interruption device to ensure that the power is automatically shut off when a short circuit occurs; and
a reset device used to return the power after said short circuit is overcome.

19. A hydroponic apparatus comprising:
a cylindrical tank which is divided by a divider into an upper portion as a growing chamber which is filled with a growing medium, and a lower portion as a reservoir of nutrient solution; and
a pump which pumps nutrient solution from said reservoir upward into said growing medium through a conduit coupled to a drip irrigation base placed at the top of said growing medium;
wherein said divider is a round member that fits into said tank, acting as a bottom of said growing chamber to support said growing medium, said round member having a smooth upper surface and a number of vertical round holes which evenly spread in a central area of said member; and
wherein said reservoir has a window from which a user observes and prunes a plant's roots which elongate downward into said reservoir through said vertical round holes, said window's upper edge being as close as possible to said divider's lower surface.

20. The hydroponic apparatus of claim 19, further comprising:
a submersible heater which is used to adjust the temperature of nutrient solution in said reservoir.

21. The hydroponic apparatus of claim 19, further comprising:
an aeration device to aerate nutrient solution in said reservoir.

22. The hydroponic apparatus of claim 21, wherein said aeration device comprises an aeration stone operatively coupled to an air pump.

23. The hydroponic apparatus of claim 19, further comprising a programmable controller to control any of:
aeration of nutrient fluid in said reservoir;
temperature of nutrient fluid in said reservoir; and
moisture of said growing medium.

24. The hydroponic apparatus of claim 19, wherein said drip irrigation base provides an array of drip holes facing upward from which nutrient solution evenly covers said growing medium.

25. The hydroponic apparatus of claim 19, wherein said drip irrigation base comprises one input conduit connected to at least two circular conduits on which various drip holes facing upward are evenly made.

26. The hydroponic apparatus of claim 19, wherein said growing medium can be any of:
peat moss
coco fiber;
lava rocks;
clay pebbles; and
rockwool.

27. The hydroponic apparatus of claim 19, wherein each of said vertical round holes is approximately 5/16-⅜ inch in diameter.

28. The hydroponic apparatus of claim 19, wherein said central area is an area whose diameter is approximately one-third of said divider's diameter.

29. The hydroponic apparatus of claim 19, wherein said central area is slightly higher, with a smooth slope, than the surrounding area of said divider's upper surface to lead a plant's primary roots to elongate toward the surrounding wall of said growing chamber.

30. The hydroponic apparatus of claim 19, wherein said window is opened and closed using a sliding door.

31. The hydroponic apparatus of claim 19, further comprising a drainage which is used to empty said reservoir.

32. The hydroponic apparatus of claim 19, further comprising a trestle coupled to said tank's upper portion, said trestle comprising:
a connection agency for connection with said tank; and
a number of rods with a same length, the lower ends of said rods being coupled to said connection agency.

33. The hydroponic apparatus of claim 32, wherein said trestle further comprises a web stretched by the upper ends of said rods.

34. The hydroponic apparatus of claim 32, wherein said connection agency covers, around said tank's upper rim, approximately one-third to one-half of said tank's top surface to keep a particular humidity of said growing medium.

35. The hydroponic apparatus of claim 19, further comprising a lighting device coupled to said trestle to promote photosynthesis.

36. The hydroponic apparatus of claim 19, further comprising:
a power interruption device to ensure that the power is automatically shut off when a short circuit occurs; and
a reset device used to return the power after said short circuit is overcome.
